(19) United States
(12) Patent Application Publication
(10) Pub. No.: US 2007/0151801 A1
(43) Pub. Date: Jul. 5, 2007

(54) Collapsible ladder cage

(75) Inventor: Mark Talley, (US)

Correspondence Address: FULBRIGHT & JAWORSKI, LLP, 1301 MCKINNEY, SUITE 5100, HOUSTON, TX, 77010-3095, US

(73) Assignee: Starcon International, Inc., Manhattan, IL (US)

(21) Appl. No.: 11/323,588

(22) Filed: Dec. 30, 2005

(51) Int. Cl. E06C 7/18

(52) U.S. Cl. 182/106

(57) ABSTRACT

A collapsible ladder cage segment having an upper and lower end for attachment to a ladder. The cage segment including at least one rigid support member positioned proximate the upper end of the cage segment and a plurality of flexible support members. The rigid support member and the plurality of flexible support members are substantially in spaced parallel alignment with other. A plurality of flexible longitudinal members are positioned in spaced relationship around the circumference of the support members, substantially normal to the support members, forming a cage-like arrangement. Securing assemblies are on at least one rigid support member for securing the rigid support member to a portion of the ladder so as to secure the segment to the ladder. The unsecured ladder cage segment is capable of collapsing for transportation and storage.

### TECHNICAL FIELD

The present invention is directed to safety cages for ladders and more specifically to collapsible ladder cages and collapsible ladder cage systems.

### BACKGROUND OF THE INVENTION

The current OSHA regulation for ladders (29 CFR 1910.27) requires that fixed ladders over 20 feet in length be equipped with cages or ladder safety devices. The bottom cage unit must have a larger diameter at the lower end than at the upper end of the unit and the bottom edge of the unit must be located a minimum of 7 feet and a maximum of 8 feet above the ground. OSHA requires that the cages must not extend less than 27 or more than 28 inches from the centerline of the rungs of the ladder and must not be less than 27 inches in width.

Cages are typically formed from a plurality of U-shaped horizontal members to which a plurality of vertical metal structural members are attached at the circumference of the U-shaped members to form a cage-like arrangement in case a worker falls while on the ladder. The most common cages are welded rigid one-piece assemblies designed for attachment to fixed ladders. Standard cage lengths are typically from 7 to 27 feet in which a series of cages can be stacked on a fixed ladder. U.S. Pat. No. 5,255,758 describes a safety cage assembly for a ladder and welded steel cages for use on a fixed ladder are available from the Bondor Manufacturing Company in Providence, R.I.

A collapsible safety guard for derrick ladders is described in U.S. Pat. No. 2,539,664 in which a series of spaced-apart U-shaped angle iron brackets have spaced-apart openings through which a series of chains are threaded. The safety guard of the '664 patent is secured directly to the derrick rather than the ladder and is constructed such that it only need be partially disassembled when the derrick is moved from one location to another.

Currently in the scaffolding industry, ladders between scaffolding platforms are un-caged because according to OSHA requirements, these are temporary ladders and thus do not require cages. This leaves workers on scaffolding structures at great risk because caged ladders are very heavy and difficult to install on temporary scaffold structures.

It would be desirable to have a flexible collapsible ladder cage that is light weight yet can be easily secured to both temporary and fixed ladders. It would further be desirable to have a ladder cage for temporary ladders that meets OSHA's requirements for fixed ladders.

### BRIEF SUMMARY OF THE INVENTION

The present invention is directed to a collapsible ladder cage segment comprising at least one rigid U-shaped support member positioned proximate the upper end of the cage segment and a plurality of flexible U-shaped support members. The rigid support member and the plurality of flexible support members are generally in a spaced parallel alignment with each other. A plurality of flexible longitudinal members are positioned in spaced relationship around the circumference of the rigid and flexible U-shaped support members, and are substantially normal to the U-shaped support members, forming a cage-like arrangement. There is a securing assembly on at least one rigid U-shaped support member for securing the rigid support member to a portion of a ladder. The unsecured ladder cage segment is capable of collapsing on itself for transportation and storage.

The present invention is also directed to a collapsible ladder cage system comprising a first cage segment and at least a second cage segment. The first cage segment has an upper rigid U-shaped support member and a lower rigid U-shaped support member. A plurality of flexible support members are spaced between the upper and lower rigid support members generally in a spaced substantially parallel alignment with each other. A plurality of flexible longitudinal members are positioned in spaced relationship around the circumference of the rigid and flexible support members and are substantially normal to the support members, forming a cage-like arrangement. The lower rigid support member has a larger diameter (and hence a larger circumference) than the upper rigid support member. This results in a flared opening. The at least second cage segment has an upper rigid U-shaped support member and a lower rigid U-shaped support member, in which a plurality of flexible support members are spaced between the upper and lower rigid support members generally in a spaced substantially parallel alignment with each other. A plurality of flexible longitudinal members are positioned in spaced relationship around the circumference of the rigid and flexible support members and are substantially normal to the support members, forming a cage-like arrangement. Both cage segments have securing assemblies on at least one of the rigid U-shaped support members for securing the cage segments to a portion of a ladder. It should be understood that the first cage segment having the lower rigid support member with the larger diameter may be the only segment used, and generally would be the lower cage segment used in a multi-cage segment assembly.

The first cage segment is positioned at the bottom of the ladder and the second cage segment is positioned on the ladder a spaced apart distance above the first cage segment. It is contemplated that a plurality of second cage segments can be utilized in the system. Each of the cage segments, once unsecured, are capable of collapsing on itself for transportation and storage. If a plurality of cage segments are used, the present invention describes a collapsible cage system.

The collapsible ladder cage segments of the present invention meet the OSHA regulation for fixed ladders.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a side elevation of a portion of the collapsible ladder cage system of the present invention attached to a ladder;

FIG. 2 is a side elevation view of a lower collapsible ladder cage segment of the present invention;

FIG. 3 is a side view of the cage segment of FIG. 2 in a collapsed state;

FIG. 4 is a side elevation view of the lower cage segment of the system of FIG. 1;

FIG. 5 is a front elevation view of the cage segment of FIG. 4;

FIG. 6A is a top plan view of one of the cage segments of FIG. 1 illustrating one embodiment of the securing assembly of a cage segment;

FIG. 6B is a top plan view of one of the cage segments of FIG. 1 illustrating another embodiment of the securing assembly of a cage segment;

FIG. 6C is a top plan view of one of the cage segments of FIG. 1 illustrating a further embodiment of the securing assembly of a cage segment;

FIG. 7 is an enlarged detail of the securing assembly of the collapsible ladder cage system for the embodiment shown in FIGS. 6A and 6B;

FIG. 8 is another enlarged detail of the securing assembly of the collapsible ladder cage system shown in FIG. 7;

FIG. 9 is a detail view of a T-bolt of the securing assembly of FIGS. 7 and 8; and

FIG. 10 is a end view of the T-bolt of FIG. 9.

### DETAILED DESCRIPTION OF THE INVENTION

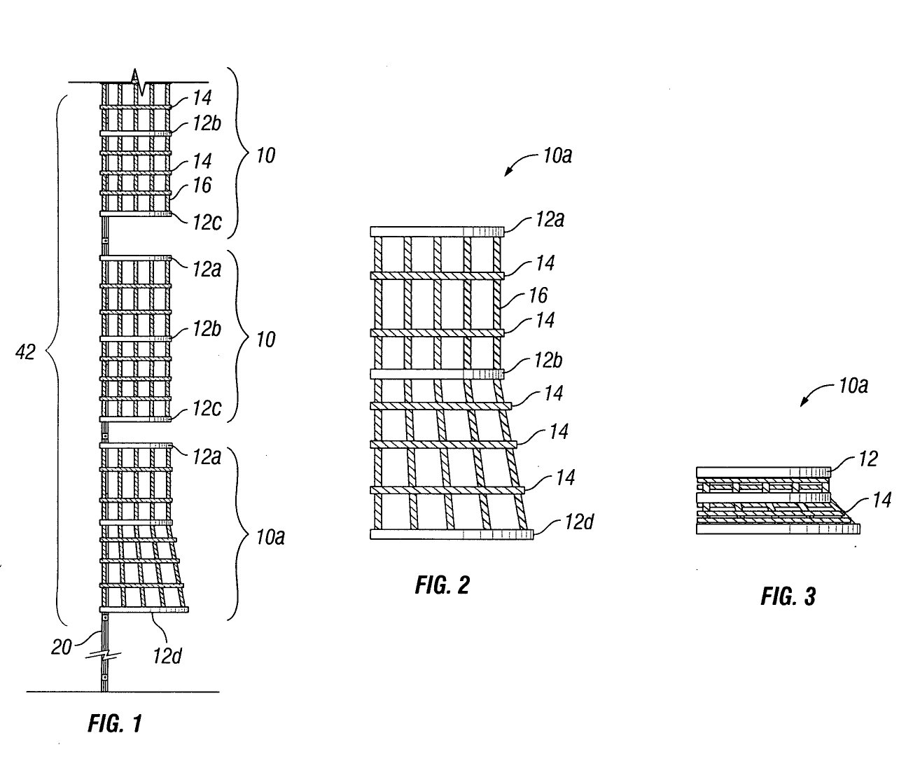

Referring to FIGS. 1-5, the present invention is directed to a collapsible ladder cage system 42 having a cage segment 10 that is used on ladders as a safety device. Each collapsible ladder cage segment 10 includes at least one rigid support member 12, preferably U-shaped, positioned at the upper edge of the cage 10 and a plurality of flexible support members 14, preferably U-shaped. The support members 12, 14 are generally in a spaced substantially parallel alignment and as shown in FIG. 1 as having a horizontal attitude. In one embodiment, the cage segment 10 includes at least three rigid support members 12a, 12b, 12c and a plurality of flexible support members 14 positioned between each of the rigid support members 12a, 12b, 12c. However, four, five or more rigid support members 12 could be used in which a plurality of the flexible support members 14 would be positioned between each of the rigid support members 12. In a preferred embodiment, a first rigid support member 12a is positioned proximate an upper end or edge of the cage segment, a third rigid support member 12c is positioned proximate a lower end or edge of the cage segment 10 and a second rigid support member 12b is positioned in a middle section of the cage segment between the first and third support members 12a, 12c. In one embodiment of the cage segment 10, the lower rigid support member 12d has a larger diameter than the rigid support members 12a, 12b positioned above it, thereby providing a larger circumference around the lower support member 12d than support members 12a or 12b.

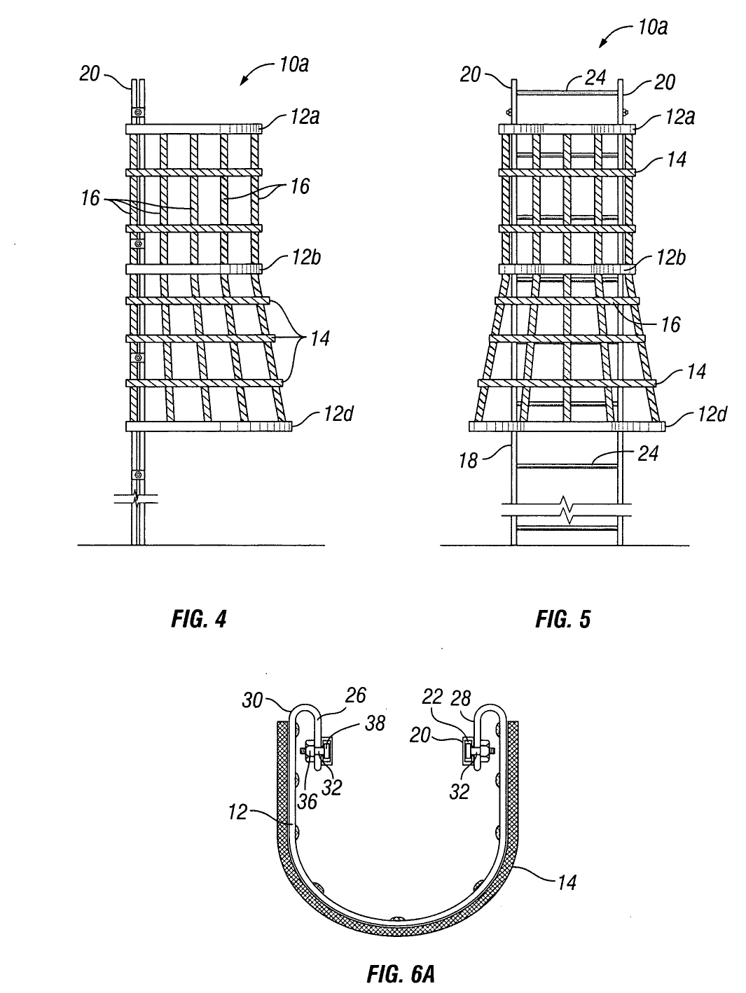

A plurality of flexible longitudinal members 16 are positioned in spaced relationship around the circumference of the support members 12, 14, substantially normal to the support members 12, 14, forming a cage-like arrangement. In one embodiment, the number of longitudinal members 16 can range from six to twelve depending one the diameter of the rigid support members 12, 14. In a preferred embodiment, the number of longitudinal members 16 can range from eight to twelve. The flexible longitudinal members 16 spaced around the circumference of the support members 12, 14 allow the unsecured ladder cage segment 10 to collapse on itself for transportation and storage. Since the diameter, and hence the circumference, of support member 12d is larger than support members 12a and 12b, the cage segment 10a provides a flared section 10e (FIG. 4) for ease of entry and exit into the cage segment 10a.

The flexible support members 14 and the flexible longitudinal members 16 can be formed from material such as nylon, cable formed from metal or a synthetic material or chain formed from metal. The rigid support members 12 are typically formed from metal such as steel.

In one embodiment of the collapsible ladder cage system 42, the first cage segment 10a is positioned at the bottom of the ladder 18 and the at least one second cage segment 10 is positioned on the ladder a spaced apart distance above the first cage segment 10a (FIG. 1). Depending upon the height of the ladder in which the collapsible cage system 42 is being attached, a plurality of second cages segments 10 will be utilized in which each of the plurality of second cages segments 10 is positioned on the ladder 18 a spaced apart distance above each other. Each of the cage segments 10a, 10 in the system 42 is capable of collapsing on itself for transportation and storage.

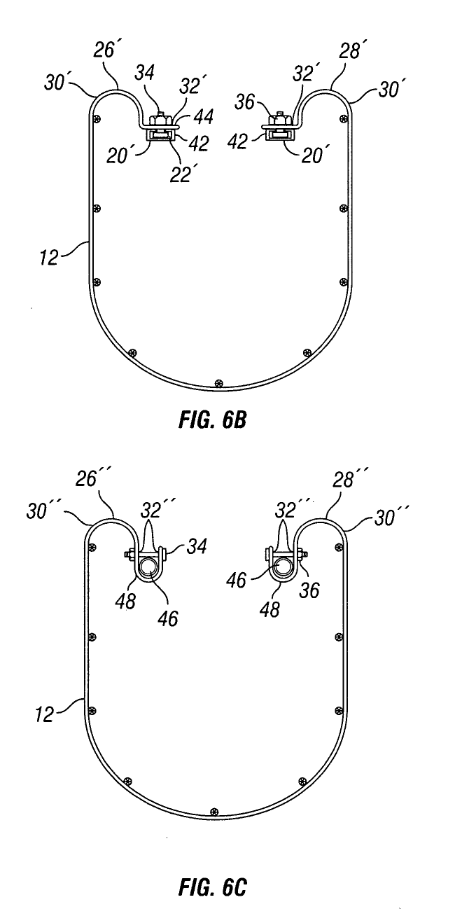

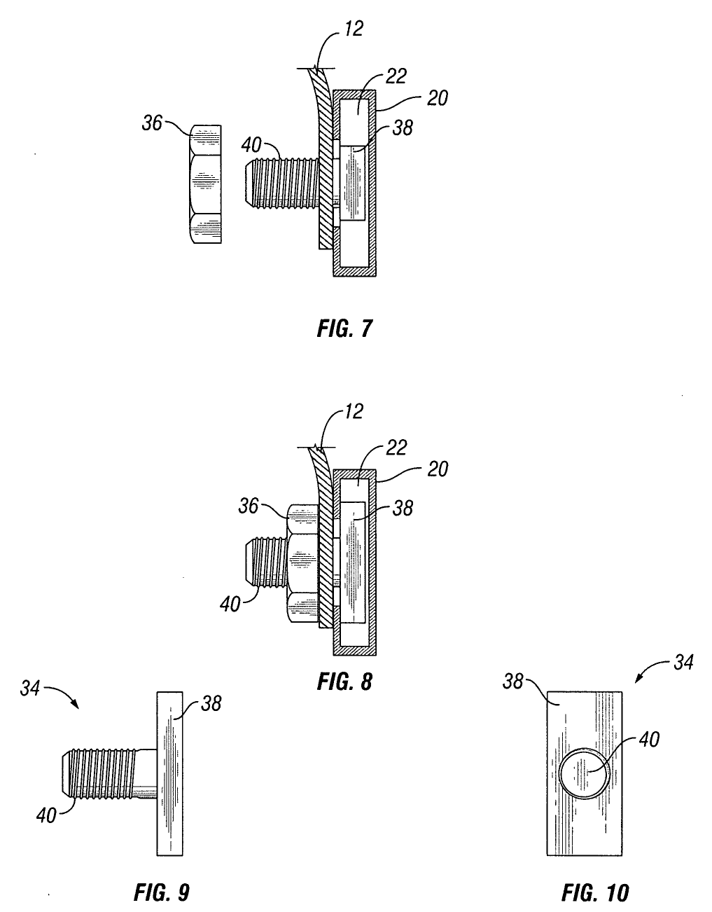

Referring to FIGS. 4-10, each of the cage segments 10 includes an assembly for securing it to a ladder 18. The cage segments 10 can be secured to the ladder 18 in a number of ways, depending upon the profile of the ladder. As known by one skilled in the art, a ladder's rungs 24 are horizontally placed between the sides 20 of the ladder 18. In certain industrial ladders, the vertical side members 20 can have a cross-sectional C-shaped rectangular profile forming a continuous longitudinal channel 22 along the outside of each of side members 20. As shown in FIG. 6A, in one embodiment of the securing assembly, the rigid support members 12 each have a first and second end portion 26, 28, in which each end portion 26, 28 is turned inward forming a J-shape 30. The first and second end portions 26, 28 each include an aperture 32 sized and shaped for threading a bolt therethrough. A T-bolt 34, having a rectangular first end 38 (FIGS. 9-10), is positioned in the channel portion 22 of each of the ladder's sides 20 as shown in FIG. 7, and then rotated 90° to the position shown in FIG. 8. A threaded end 40 of the bolt 34 is then threaded through the aperture 32 in each of the first and second end portions 26, 28 of the rigid support member 12. A nut 36 is threaded onto end 40 of the T-bolt 34 in order to secure each of the first and second end portions 26, 28 to the sides 20 of the ladder 18.

Referring to FIG. 6B, another embodiment is shown where the longitudinal channel 22 of side members 20′ is parallel to the rungs 24 and the rungs 24 would be attached to an end 42 of each of side members 20′. In this embodiment of the securing assembly, the first and second end portions 26′, 28′ include a curved portion 30′ and a flat portion 44 configured such that it will be in parallel alignment with the longitudinal channel 22 of side members 20′ when the cage segments 10 are positioned for securing to the ladder. The flat portion 44 includes an aperture 32′ sized and shaped for threading a bolt therethrough. The T-bolt 34 is positioned in the channel portion 22 of each of the ladder's sides 20′ as shown in FIG. 7, and then rotated 90° to the position shown in FIG. 8. The threaded end 40 of the bolt 34 is then threaded through the aperture 32′ in each of the first and second end portions 26′, 28′ of the rigid support member 12. The nut 36 is threaded onto end 40 of the T-bolt 34 in order to secure each of the first and second end portions 26′, 28′ to the sides 20′ of the ladder 18.

Referring to FIG. 6C, yet another embodiment is shown where the side members 46 of the ladder cylindrical in shape. In this embodiment of the securing assembly, the first and second end portions 26″, 28″ include a curved portion 30″ that extends into a U-shaped portion 48. The U-shaped portion 48 is configured such that one of the circular side members 46 fits within each of the U-shaped portions 48 of the first and second end portions 26″, 28″. The U-shaped portion 48 includes an aperture 32″ in each side of the U-shaped portion 48, the apertures 32″ being in alignment with each other and sized and shaped for threading a bolt therethrough. After the cylindrical side members 46 are placed within the U-shaped portion 48 of the first and second end portions 26″, 28″, the threaded end 40 of the bolt 34 is then threaded through the apertures 32″ in U-shaped portions 48. The nut 36 is threaded onto end 40 of the T-bolt 34 in order to secure each of the first and second end portions 26″, 28″ to the sides 46 of the ladder 18.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A collapsible ladder cage segment having an upper and lower end for attachment to a ladder, comprising:
at least one rigid support member positioned proximate the upper end of the cage segment;
a plurality of flexible support members;
the rigid support member and the plurality of flexible support members being in substantially spaced parallel alignment with each other;
a plurality of flexible longitudinal members positioned in spaced relationship around the circumference of the support members, the longitudinal members being substantially normal to the support members and forming a cage-like arrangement;
a securing assembly on at least one rigid support member for securing the rigid support member to a portion of a ladder so as to support the segment on the ladder;
wherein the unsecured ladder cage segment is capable of collapsing for transportation and storage.

2. The collapsible ladder cage segment of claim 1, wherein the rigid and flexible support members are generally U-shaped.

3. The collapsible ladder cage segment of claim 1, wherein the segment includes at least three rigid support members spaced substantially equal distant from each other.

4. The collapsible ladder cage segment of claim 1, wherein at least six flexible longitudinal members are positioned in spaced relationship around the circumference of each support member.

5. The collapsible ladder cage segment of claim 3, wherein a first rigid support member is positioned proximate the upper end of the cage segment, a second is positioned proximate the lower end of the cage segment and a third is positioned between the first and second support members.

6. The collapsible ladder cage segment of claim 5, wherein the second support member has a larger diameter than the first and third support members.

7. The collapsible ladder cage segment of claim 1, wherein the flexible support member are formed from material selected from a group consisting of nylon, cable formed from metal, cable formed from a synthetic material and chain formed from metal.

8. The collapsible ladder cage segment of claim 1, wherein the rigid support members each have a first and second end portion, each end portion being turned inward forming a J-shape, and each end portion further including an aperture.

9. The collapsible ladder cage segment of claim 1, wherein the rigid support members each have a first and second end portion, each end portion having a curved portion and a flat portion, and each end portion further including an aperture.

10. The collapsible ladder cage segment of claim 8 and 9, wherein the securing assembly comprises a T-bolt and nut, the T-bolt being positioned in a channel of a side of the ladder and through the aperture in each of the first and second end portion of the rigid support member, wherein the nut threads on the T-bolt to secure each of the first and second end portions to the sides of the ladder.

11. The collapsible ladder cage segment of claim 10, wherein the T-bolt is configured to fit in the channels that form the sides of the ladder.

12. The collapsible ladder cage segment of claim 1, wherein the rigid support members each have a first and second end portion, each end portion including a curved portion that extends into a U-shaped portion, each U-shaped portion including an aperture in each side of the U-shaped portion, the apertures being in alignment with each other.

13. The collapsible ladder cage segment of claim 12, wherein the securing assembly comprises a T-bolt and nut, the T-bolt being positioned through the apertures in each of the first and second end portion of the rigid support member after a side member of the ladder is placed with in the U-shaped portion of the first and second end portions.

14. The collapsible ladder cage segment of claim 13, wherein the nut threads on the T-bolt to secure each of the first and second end portions to the sides of the ladder.

15. The collapsible ladder cage segment of claim 13, wherein the side members of the ladder are cylindrical in shape.

16. A collapsible ladder cage segment having an upper and lower end for attachment to a ladder, comprising:
at least two rigid support members, one being positioned proximate the upper end of the cage segment and the second being positioned proximate the lower end of the segment;
a plurality of flexible support members;
the rigid support members and the plurality of flexible support members being in spaced substantially parallel alignment with each other, with the plurality of flexible support members being positioned between each of the rigid support members;
a plurality of flexible longitudinal members positioned in spaced relationship around the circumference of the support members, the longitudinal members being substantially normal to the support members and forming a cage-like arrangement;
a securing assembly on at least one rigid support member for securing the rigid support member to a portion of the ladder so as to support the segment on the ladder;
wherein the unsecured ladder cage segment is capable of collapsing for transportation and storage.

17. The collapsible ladder cage segment of claim 16, wherein the rigid and flexible support members are generally U-shaped.

18. The collapsible ladder cage segment of claim 16, wherein the segment includes at least three rigid support members spaced substantially equal distant from each other.

19. The collapsible ladder cage segment of claim 18, wherein a first rigid support member is positioned proximate the upper end of the cage segment, a second is positioned proximate the lower end of the cage segment and a third is positioned between the first and second support members.

20. The collapsible ladder cage segment of claim 19, wherein the second support member has a larger diameter than the first and third support members.

21. The collapsible ladder cage segment of claim 16, wherein the rigid support members each have a first and second end portion, each end portion being turned inward forming a J-shape, and each end portion further including an aperture.

22. The collapsible ladder cage segment of claim 16, wherein the rigid support members each have a first and second end portion, each end portion having a curved portion and a flat portion, and each end portion further including an aperture.

23. The collapsible ladder cage segment of claim 21 and 22, wherein the securing assembly comprises a T-bolt and nut, the T-bolt being positioned in a channel of a side of the ladder and through the aperture in each of the first and second end portion of the rigid support member, wherein the nut threads on the T-bolt to secure each of the first and second end portions to the sides of the ladder.

24. The collapsible ladder cage segment of claim 23, wherein the T-bolt is configured to fit in the channels that form the sides of the ladder.

25. The collapsible ladder cage segment of claim 16, wherein the rigid support members each have a first and second end portion, each end portion including a curved portion that extends into a U-shaped portion, each U-shaped portion including an aperture in each side of the U-shaped portion, the apertures being in alignment with each other.

26. The collapsible ladder cage segment of claim 25, wherein the securing assembly comprises a T-bolt and nut, the T-bolt being positioned through the apertures in each of the first and second end portion of the rigid support member after a side member of the ladder is placed with in the U-shaped portion of the first and second end portions.

27. The collapsible ladder cage segment of claim 26, wherein the nut threads on the T-bolt to secure each of the first and second end portions to the sides of the ladder.

28. A collapsible ladder cage system for attachment to a ladder comprising:
a first cage segment having an upper and a lower end, including:
(a) at least two rigid support members one being positioned proximate the upper end of the segment and the second being positioned proximate the lower end of the segment;
(b) a plurality of flexible support members spaced between the upper and lower support members in spaced substantially parallel alignment with each other;
(c) a plurality of flexible longitudinal members positioned in spaced relationship around the circumference of the support members, the longitudinal members being substantially normal to the support members and forming a cage-like arrangement, the lower support member having a larger diameter than the upper support member;
at least a second cage segment having
(d) at least two rigid support members one being positioned proximate the upper end of the segment and the second being positioned proximate the lower end of the segment;
(e) a plurality of flexible support members spaced between the upper and lower support members in spaced substantially parallel alignment with each other;
(f) a plurality of flexible longitudinal members positioned in spaced relationship around the circumference of the support members, the longitudinal members being substantially normal to the support members and forming a cage-like arrangement;
both cage segments having a securing assembly on at least one of the rigid support members for securing the cage segments to a portion of the ladder, wherein the first cage segment is positioned at the bottom of the ladder and the second cage segment is positioned on the ladder a spaced apart distance above the first cage segment;
wherein each of the unsecured cage segments are capable of collapsing for transportation and storage.

29. The collapsible ladder cage system of claim 28, wherein the rigid and flexible support members are generally U-shaped.

30. The collapsible ladder system of claim 28, wherein the first and second cage segments each include a middle rigid support member.

31. The collapsible ladder system of claim 28, wherein a plurality of second cage segments are utilized in the system.

32. The collapsible ladder system of claim 28, wherein at least six flexible longitudinal members are positioned in spaced relationship around the circumference of each support member.

33. The collapsible ladder cage system of claim 28, wherein the rigid support members each have a first and second end portion, each end portion being turned inward forming a J-shape, and each end portion further including an aperture.

34. The collapsible ladder cage system of claim 28, wherein the rigid support members each have a first and second end portion, each end portion having a curved portion and a flat portion, and each end portion further including an aperture.

35. The collapsible ladder cage system of claim 33 and 34, wherein the securing assembly comprises a T-bolt and nut, the T-bolt being positioned in a channel of a side of the ladder and through the aperture in each of the first and second end portion of the rigid support member, wherein the nut threads on the T-bolt to secure each of the first and second end portions to the sides of the ladder.

36. The collapsible ladder cage system of claim 35, wherein the T-bolt is configured to fit in the channels that form the sides of the ladder.

37. The collapsible ladder cage system of claim 28, wherein the rigid support members each have a first and second end portion, each end portion including a curved portion that extends into a U-shaped portion, each U-shaped portion including an aperture in each side of the U-shaped portion, the apertures being in alignment with each other.

38. The collapsible ladder cage system of claim 37, wherein the securing assembly comprises a T-bolt and nut, the T-bolt being positioned through the apertures in each of the first and second end portion of the rigid support member after a side member of the ladder is placed with in the U-shaped portion of the first and second end portions.

39. The collapsible ladder cage system of claim 38, wherein the nut threads on the T-bolt to secure each of the first and second end portions to the sides of the ladder.
